(19) United States
(12) Patent Application Publication
(10) Pub. No.: US 2005/0122523 A1
(43) Pub. Date: Jun. 9, 2005

(54) Device and method of trace gas analysis using cavity ring-down spectroscopy

(76) Inventor: Wen-Bin Yan, Cranbury, NJ (US)

Correspondence Address: RATNERPRESTIA, P O BOX 980, VALLEY FORGE, PA, 19482-0980, US

(21) Appl. No.: 10/727,929

(22) Filed: Dec. 3, 2003

(51) Int. Cl. G01N 21/00

(52) U.S. Cl. 356/437

(57) ABSTRACT

An apparatus and method for analyzing an impurity on a gas is provided. The apparatus includes a first cell containing a first gas with the impurity and a second cell containing a second gas absent the impurity. A first light beam is coupled into the first cell and a second light beam is coupled into the second cell. A first detector is coupled to an output of the first cell and generates a first signal based on a decay rate of the first light beam within the first cell. A second detector is coupled to an output of the second cell and generates a second signal based on a second decay rate of the second light beam within the second cell. The concentration of the impurity is determined based on a difference between the first decay rate and the second decay rate.

### FIELD OF THE INVENTION

This invention relates generally to absorption spectroscopy and, in particular, is directed to the detection of trace species in gases using cavity ring-down cavity spectroscopy.

### BACKGROUND OF THE INVENTION

Referring now to the drawing, wherein like reference numerals refer to like elements throughout, FIG. 1 illustrates the electromagnetic spectrum on a logarithmic scale. The science of spectroscopy studies spectra. In contrast with sciences concerned with other parts of the spectrum, optics particularly involves visible and near-visible light—a very narrow part of the available spectrum which extends in wavelength from about 1 mm to about 1 nm. Near visible light includes colors redder than red (infrared) and colors more violet than violet (ultraviolet). The range extends just far enough to either side of visibility that the light can still be handled by most lenses and mirrors made of the usual materials. The wavelength dependence of optical properties of materials must often be considered.

Absorption-type spectroscopy offers high sensitivity, response times on the order of microseconds, immunity from poisoning, and limited interference from molecular species other than the species under study. Various molecular species can be detected or identified by absorption spectroscopy. Thus, absorption spectroscopy provides a general method of detecting important trace species. In the gas phase, the sensitivity and selectivity of this method is optimized because the species have their absorption strength concentrated in a set of sharp spectral lines. The narrow lines in the spectrum can be used to discriminate against most interfering species.

In many industrial processes, the concentration of trace species in flowing gas streams and liquids must be measured and analyzed with a high degree of speed and accuracy. Such measurement and analysis is required because the concentration of contaminants is often critical to the quality of the end product. Gases such as N₂, O₂, H₂, Ar, and He are used to manufacture integrated circuits, for example, and the presence in those gases of impurities—even at parts per billion (ppb) levels—is damaging and reduces the yield of operational circuits. Therefore, the relatively high sensitivity with which water can be spectroscopically monitored is important to manufacturers of high-purity gases used in the semiconductor industry. Various impurities must be detected in other industrial applications. Further, the presence of impurities, either inherent or deliberately placed, in liquids have become of particular concern of late.

Spectroscopy has obtained parts per million (ppm) level detection for gaseous contaminants in high-purity gases. Detection sensitivities at the ppb level are attainable in some cases. Accordingly, several spectroscopic methods have been applied to such applications as quantitative contamination monitoring in gases, including: absorption measurements in traditional long pathlength cells, photoacoustic spectroscopy, frequency modulation spectroscopy, and intracavity laser absorption spectroscopy. These methods have several features, discussed in U.S. Pat. No. 5,528,040 issued to Lehmann, which make them difficult to use and impractical for industrial applications. They have been largely confined, therefore, to laboratory investigations.

In contrast, continuous wave-cavity ring-down spectroscopy (CW-CRDS) has become an important spectroscopic technique with applications to science, industrial process control, and atmospheric trace gas detection. CW-CRDS has been demonstrated as a technique for the measurement of optical absorption that excels in the low-absorbance regime where conventional methods have inadequate sensitivity. CW-CRDS utilizes the mean lifetime of photons in a high-finesse optical resonator as the absorption-sensitive observable.

Typically, the resonator is formed from a pair of narrow band, ultra-high reflectivity dielectric mirrors, configured appropriately to form a stable optical resonator. A laser pulse is injected into the resonator through a mirror to experience a mean lifetime which depends upon the photon round-trip transit time, the length of the resonator, the absorption cross section and number density of the species, and a factor accounting for intrinsic resonator losses (which arise largely from the frequency-dependent mirror reflectivities when diffraction losses are negligible). The determination of optical absorption is transformed, therefore, from the conventional power-ratio measurement to a measurement of decay time. The ultimate sensitivity of CW-CRDS is determined by the magnitude of the intrinsic resonator losses, which can be minimized with techniques such as superpolishing that permit the fabrication of ultra-low-loss optics.

FIG. 1B illustrates a conventional CW-CRDS apparatus 120 for analyzing the impurity in a gas. In FIG. 1B, a gas containing an impurity is introduced into cavity ring-down cell 108. Cavity ring-down cell 108, is filled with the impure gas and pressure regulator 112 coupled to cell 108 maintains a constant pressure within the cell.

Light 101 is emitted from laser 100, which is tuned to a predetermined frequency consistent with the absorption frequency of the impurity. Light 101 is collected and focused by lens (or lens system) 102 and resultant light beam 101a is coupled into ring-down cell 108. Once coupled into cell 108, light beam 101a contacts reflective mirrors 124 and 125, which act as a stable optical resonator and cause optical excitation. The laser is then shut off. As the mirrors reflect the light inside cell 108, a portion of the light is absorbed by the gas in cell 108. This ring-down signal decays with time.

Output detector 114 coupled to the ring-down cell 108 measures the ring-down rate in the cell. Output signal 115 is indicative of the ring-down rate in cell 108 and is transmitted to processor 118. Processor 118 then interprets the ring-down rate and calculates the concentration of the impurity by comparing the ring-down rate in cell 108 at the peak of an absorption line of the impurity to the ring-down rate at the baseline, where no absorption occurs.

Conventional CW-CRDS can accurately determine the concentration of an impurity in a gas as long as there is no interference in the peak or baseline background; for example, in systems where inert gases are the carrier gases and water is the impurity. However, in many gas systems the carrier gas and the impurity have overlapping spectral features. Where these overlapping spectral features occur, there is no interference-free peak or baseline and the concentration of the impurity cannot be accurately determined using conventional CW-CRDS.

In another conventional system, intensity of light in a cell is used to determine the impurity in a gas. One example of this technique is U.S. Pat. No. 6,040,915 to Wu, et al. This system has disadvantages, however, in that the space from the laser to the cell and from the cell to the detector contribute to the signals. Measurement error can occur if there is a mismatch or variation in the laser beam paths. Also, when detecting moisture, the beam paths must be purged, normally using high purity nitrogen, to reduce external interference. This purging increases operating cost. Additionally, any mismatch in detectors and amplifiers cause measurement errors. Another disadvantage in using light intensity measuring systems is that the etalon effect in the two beams must be similar for cancellation when subtracted.

To overcome the shortcomings of conventional systems, an improved system and method for analyzing trace species in gases using CW-CRDS is provided.

### SUMMARY OF THE INVENTION

To achieve that and other objects, and in view of its purposes, the present invention provides an apparatus and method for analyzing an impurity in a gas. The apparatus includes a first cell at least partially containing a first gas with the impurity and a second cell at least partially containing a second gas absent the impurity. A light splitter is optically coupled to the light source and splits the light into a first light beam and a second light beam. The first light beam is coupled into an input of the first cell and the second light beam is coupled into an input of the second cell. A first detector is coupled to an output of the first cell and generates a first signal based on a decay rate of the first light beam within the first cell. Additionally, a second detector is coupled to an output of the second cell and generates a second signal based on a second decay rate of the second light beam within the second cell. The concentration of the impurity is determined based on a difference between the first decay rate and the second decay rate.

According to another aspect of the invention, a processor is coupled to the first detector and the second detector to receive and process the first signal and the second signal to determine the concentration of the impurity.

According to a further aspect of the invention, the first light beam and the second light beam have an identical wavelength.

According to yet another aspect of the invention, a pressure of the first gas in the first cell and a pressure of the second gas in the second cell are substantially identical.

According to still another aspect of the invention, the light emitting source comprises a CW laser.

According to still a further aspect of the invention, the concentration of the impurity is determined by comparing a ring-down rate at a peak of an absorption line of the impurity of the gas to a baseline ring-down rate absent the impurity.

According to yet a further aspect of the invention, the method includes the steps of introducing a first gas containing the impurity into at least a portion of a first cell; introducing a second gas absent the impurity into at least a portion of a second cell; emitting a light from a light source; splitting the light from the light source into a first beam and a second beam; directing the first beam of light through the first cell; directing the second beam of light through the second cell; measuring a decay rate of the first beam of light in the first cell; measuring a decay rate of the second beam of light in the second cell; and determining a concentration of the impurity in the gas based on a difference between the decay rates of the first and second cells.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of various features are arbitrarily expanded or reduced for clarity. Included in the drawing are the following figures:

FIG. 1A illustrates the electromagnetic spectrum on a logarithmic scale;

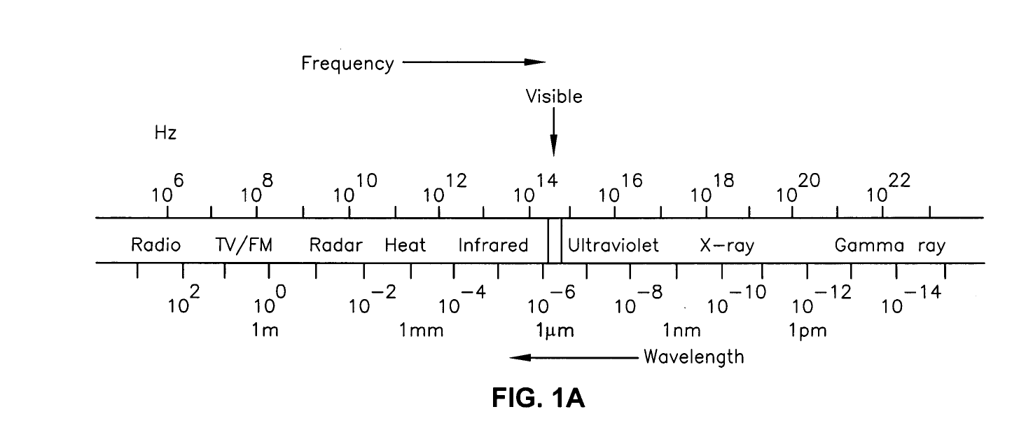

FIG. 1B illustrates a prior art CRDS system using a single ring-down cell;

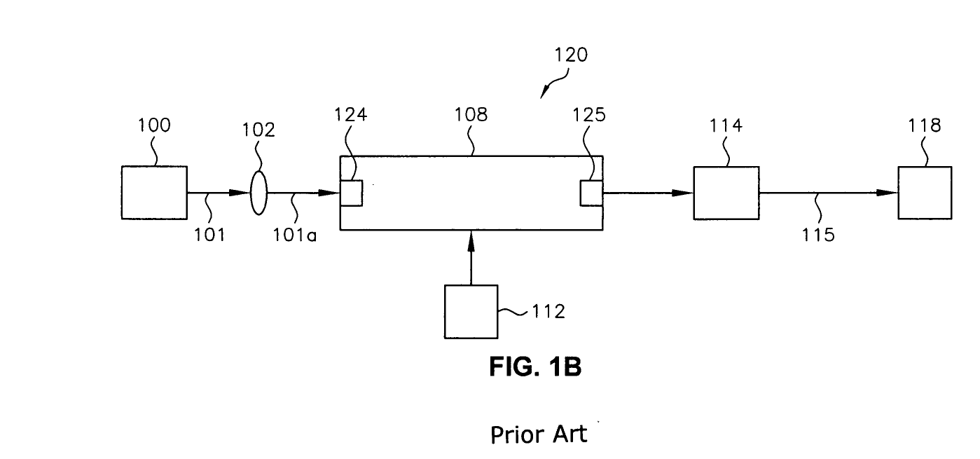

FIG. 2 illustrates the first exemplary embodiment of the present invention;

FIG. 3 illustrates a second exemplary embodiment of the present invention; and

FIG. 4 illustrates a third exemplary embodiment of the present invention.

### DETAILED DESCRIPTION OF THE INVENTION

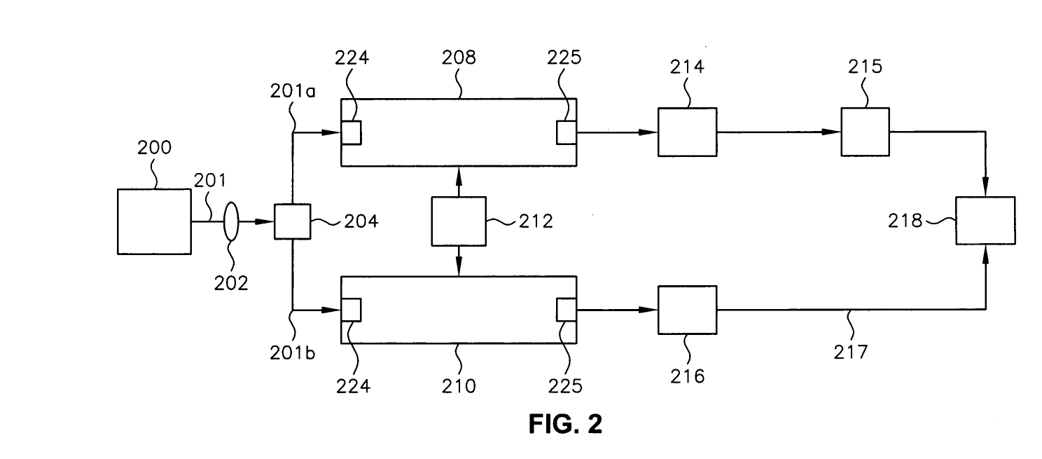

FIG. 2 illustrates a first exemplary embodiment of the present invention. In FIG. 2, a gas containing an impurity, such as an analyte, is introduced into ring-down cell 208 and a gas absent the impurity is introduced into ring-down cell 210. Ring-down cells 208, 210, which may be, but are not limited to, cavity ring-down cells, can either be filled with their respective gases or the gases may be introduced by flowing the gases through the cells. (A detailed explanation of cavity ring-down spectroscopy is not provided herein as the technology is well-known to those skilled in the art.) In one exemplary embodiment, pressure regulator 212 coupled to each of cells 208, 210 maintains substantially identical pressures within the cells.

Light 201 is emitted from tuneable light source 200, such as a CW laser, for example. Light source 200 is tuned to a predetermined frequency that is consistent with the absorption frequency of the impurity. Light 201 is collected and focused by device 202, such as a lens, and split by beam splitter 204, which is optically coupled to light source 200. Light 201 is split into two approximately equal beams 201a, 201b of identical wavelength. Substantially simultaneously, first light beam 201a is coupled into first ring-down cell 208, and second light beam 201b is coupled into the second ring-down cell 210. Once coupled into their respective cells 208, 210, light beams 201a, 201b contact reflective mirrors 224 and 225, which act as a stable optical resonator, and cause optical excitation . The light source is then shut off. As the mirrors reflect the light inside cells 208, 210, a portion of the light is absorbed by the gas in the cell. This ring-down signal decays with time.

First output detector 214 coupled to the first cell and second output detector 216 coupled to the second cell measure the decay rate in each cell, independently of one another. Output signals 215, 217. respectively are indicative of the decay rate in cells, 208, 210 and are provided to processor 218. Processor 218 then interprets the decay signals and calculates the concentration of the impurity by determining the difference between the decay rate in first cell 208 and the decay rate in second cell 210.

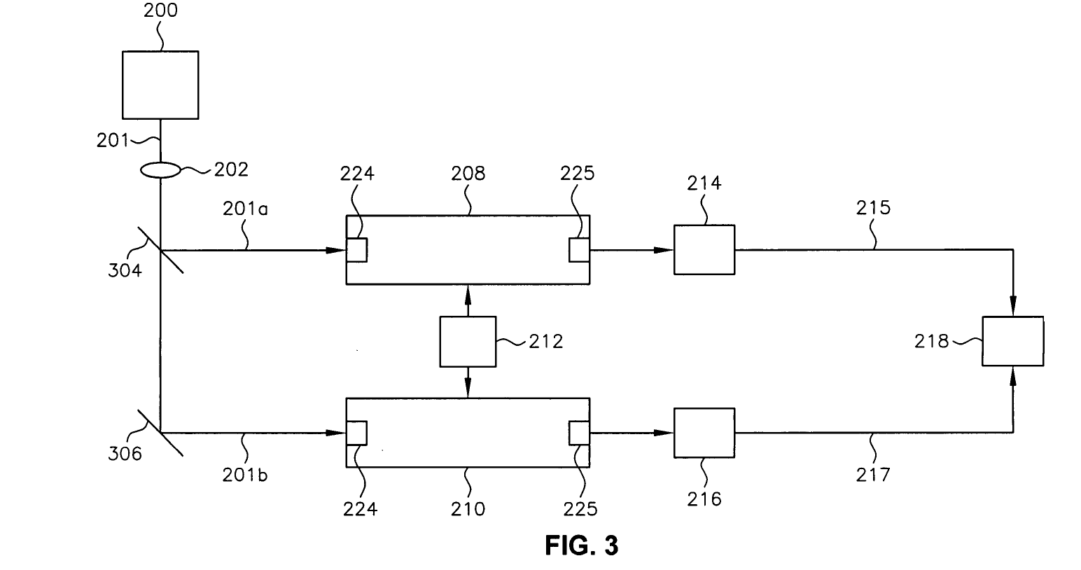

FIG. 3 illustrates a second exemplary embodiment of the present invention through which impurities, such as analytes, in gases can be detected. With respect to FIG. 3, elements performing similar functions will be described with respect to the first exemplary embodiment and will use identical reference numerals. The embodiment of FIG. 3 is substantially the same as the embodiment described above with reference to FIG. 2, the difference being that light 201 is split into approximately equal beams of light 201a, 201b of identical wavelength by half mirror 304, which passes a portion (201b) of the beam and reflects a remaining portion (201a) of the beam toward first ring-down cell 208. The filtered out portion of the beam is then reflected (if necessary) by mirror 306 into second ring-down cell 210. In all other aspects this exemplary embodiment is similar to the first exemplary embodiment.

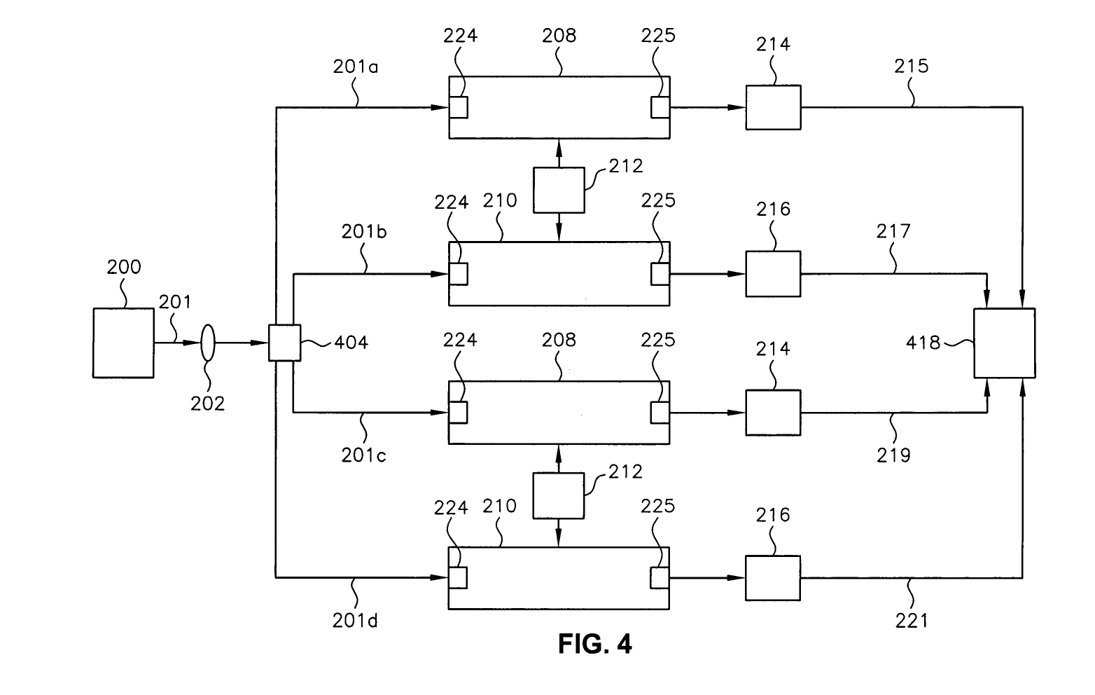

FIG. 4 illustrates a third exemplary embodiment of the present invention. With respect to FIG. 4, elements performing similar functions will be described with respect to the first exemplary embodiment and will use identical reference numerals. This embodiment provides a process for analyzing multiple gases each with different impurities and determining the concentration of the impurity with respect to a reference gas absent these impurities. The embodiment of FIG. 4 is substantially the same as the embodiment described above with reference to in FIG. 2. The difference being that light is separated into multiple beams (four in this particular example) of identical wavelengths by beam splitter 404. After the light beams 201a, 201b, 201c, 201d, pass through the cells and the respective decay rates are measured by detectors 214, 216, processor 418 determines the level of the impurity in each gas by calculating the difference between the decay rate in the first cell and the decay rates in the other cells, independently of one another. Although this exemplary embodiment is described with respect to a single light source 200 providing a single wavelength of light, the invention is not so limited. It is also contemplated that the light source may generate light of multiple frequencies, such that independent pairs of systems, such as described above with respect to FIG. 2 may be coupled to splitter 404, such that splitter 404 provides light of one frequency to a first pair of cells, and light of a second frequency to a second pair of cells, for example.

The present invention is applicable to a variety of gas systems and has an advantage over the prior art for providing more accuracy in systems where the gas containing the impurity has spectral features that overlap those of the impurity. One non-limiting example would be ammonia containing water as the impurity. The present invention also has the advantage over the prior art in that external interference that disrupts light intensity as it enters and exits the cell is eliminated because ring-down rates measure the concentration of the impurity based on time and not intensity. As a result, unlike dual-cell tunable diode laser absorption spectroscopy (TDLAS), the current invention does not require beam paths between the light source and the cell and the cell and the detector to be purged with high purity nitrogen when used to detect moisture. The current invention is also unaffected by variances in the beams, mismatches in the detectors that limit the sensitivity of TDLAS systems, and distortions resulting from etalon effects.

As another advantage over the prior art, another embodiment of the present invention involves the ability to compare the peak absorption line with the baseline ring-down rate, or the ring-down rate without the impurity. Still another advantage is the capability of measuring the baseline ring-down rate, measured at an off peak location, which allows extrapolation to the peak wavelength. Alternatively, by measuring the whole peak profile, containing strength and lineshape information, concentration of the impurity is determined by fitting the lineshape.

Although the invention is illustrated and described herein with reference to specific embodiments, the invention is not intended to be limited to the details shown. Rather, various modifications may be made in the details within the scope and range of equivalents of the claims and without departing from the invention.

1. A method for analyzing an impurity in a gas, comprising the steps of:
introducing a first gas containing the impurity into at least a portion of a first cell;
introducing a second gas absent the impurity into at least a portion of a second cell;
emitting a light from a light source;
splitting the light from the light source into a first beam and a second beam;
directing the first beam of light through the first cell;
directing the second beam of light through the second cell;
measuring a decay rate of the first beam of light in the first cell;
measuring a decay rate of the second beam of light in the second cell; and
determining a concentration of the impurity in the gas based on a difference between the decay rates of the first and second cells.

2. The method according to claim 1, further comprising the step of maintaining substantially identical pressures within the first cell and the second cell.

3. The method according to claim 1, wherein the first beam of light and the second beam of light have an identical wavelength.

4. The method according to claim 1, further comprising the step of tuning the light source to a predetermined frequency.

5. The method according to claim 1, further comprising the step of analyzing the first gas and the second gas using cavity ring-down spectroscopy.

6. The method according to claim 5, wherein the first cell is filled with the first gas and the second cell is filled with the second gas.

7. The method according to claim 5, wherein the first gas flows through the first cell and the second gas flows through the second cell.

8. The method according to claim 5, wherein the first cell is filled with the first gas and the second gas flows through the second cell.

9. An apparatus for analyzing an impurity in a gas for use with a light source, comprising:
a first cell at least partially containing a first gas with the impurity;
a second cell at least partially containing a second gas absent the impurity;
a splitter optically coupled to the light source to split the light from the light source into a first light beam and a second light beam, the first light beam coupled into an input of the first cell and the second light beam coupled into an input of the second cell;
a first detector coupled to an output of the first cell and generating a first signal based on a decay rate of the first light beam within the first cell; and
a second detector coupled to an output of the second cell and generating a second signal based on a second decay rate of the second light beam within the second cell,
wherein a concentration of the impurity is determined based on a difference between the first decay rate and the second decay rate.

10. The apparatus according to claim 9, further comprising a processor coupled to the first detector and the second detector to receive and process the first signal and the second signal to determine the concentration of the impurity.

11. The apparatus according to claim 9, wherein the first light beam and the second light beam have an identical wavelength.

12. The apparatus according to claim 9, wherein the first detector measures the decay rate of the first light beam in the first cell.

13. The apparatus, according to claim 9, wherein the second detector measures the decay rate of the second light beam in the second cell.

14. The apparatus according to claim 9, wherein a pressure of the first gas in the first cell and a pressure of the second gas in the second cell are substantially identical.

15. The apparatus according to claim 9, wherein the gas comprises ammonia and the impurity comprises water.

16. The apparatus according to claim 9, wherein the light emitting source comprises a CW laser.

17. The apparatus according to claim 16, wherein the laser is tuneable.

18. The apparatus according to claim 9, wherein the first cell and the second cell each comprise a cavity ring-down spectroscopy cell.

19. The apparatus according to claim 18, wherein the concentration of the impurity is determined by comparing a ring-down rate at a peak of an absorption line of the impurity of the gas to a baseline ring-down rate absent the impurity.

20. The apparatus according to claim 18, wherein the concentration of the baseline ring-down rate is measured at an off-peak profile based on extrapolation to a peak wavelength.

21. The apparatus according to claim 18, wherein the concentration of the impurity is determined based on a measurement of a whole peak profile, which contains a strength and a lineshape formation, the concentration of the impurity being determined by fitting the lineshape.

22. The apparatus according to claim 18, wherein the first cell is filled with the first gas and the second cell is filled with the second gas.

23. The apparatus, according to claim 18, wherein the first gas flows through the first cell and the second gas flows through the second cell.

24. The apparatus, according to claim 18, wherein the first cell is filled with the first gas and the second gas flows through the second cell.

25. An apparatus for analyzing an impurity in a gas, comprising:
means for introducing a first gas containing an impurity into a first cell and a gas absent impurity into a second cell;
means for emitting a light into the first cell and the second cell;
means for determining respective decay rates of the light in the first cell and the second cell; and
means for determining a concentration of the impurity in the gas based on a difference between the respective decay rates in the first cell and the second cell.
